(19) United States
(12) Patent Application Publication
(10) Pub. No.: US 2025/0255210 A1
(43) Pub. Date: Aug. 14, 2025

(54) INDEPENDENT FRONT AND REAR GANG ANGLE CONTROL FOR A TILLAGE IMPLEMENT

(71) Applicant: CNH Industrial America LLC, New Holland, PA (US)

(72) Inventors: Timothy Richard Blunier, Danvers, IL (US); Brice Magarity, Deer Creek, IL (US)

(21) Appl. No.: 18/436,200

(22) Filed: Feb. 8, 2024

(51) Int. Cl. A01B 79/00; A01B 35/16; A01B 63/32

(52) U.S. Cl. CPC A01B 79/005; A01B 35/16; A01B 63/32

(57) ABSTRACT

A system and method include receiving inputs specifying angles for a first set of disc gangs and/or a second set of disc gangs of a tillage implement. The system and method include providing control signals to actuators to independently alter respective angles of the first set of disc gangs and the second set of disc gangs, wherein each disc gang of both the first set of disc gangs and the second set of disc gangs includes a plurality of discs coupled to a frame member coupled to a main frame, the main frame includes a front portion and a rear portion relative a direction of travel of the tillage implement, the first set of disc gangs is located at the front portion, and the second set of disc gangs is located at the rear portion.

### BACKGROUND

The present disclosure relates to independent front and rear angle control for a tillage implement.

Certain agricultural implements include ground engaging tools configured to interact with soil. For example, a tillage implement may include disc blades configured to break up the soil for subsequent planting or seeding operations. Groups of disc blades may be arranged in gangs, and each gang of disc blades may be rotatably coupled to a frame of the tillage implement. In certain tillage implements, an angle of each gang may be adjustable relative to the frame, thereby facilitating adjustment of the angle of the disc blades of the gang relative to a direction of travel of the tillage implement. For example, the gang of disc blades may be rotatably coupled to a gang support, and the gang support may be pivotally coupled to the frame of the tillage implement. Accordingly, the angle of the disc blades of the gang relative to the direction of travel may be adjusted by rotating the gang support relative to the frame. However, the angle of the gangs in both the front and rear of the tillage implement cannot be independently controlled, thus, limiting the speed of the tillage implement to a narrower speed range.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In certain embodiments, a system for independently controlling front and rear gang angles on a tillage implement is provided. The system includes a controller. The controller includes a memory encoding processor-executable routines. The controller also includes a processing system configured to access the memory and to execute the processor-executable routines, wherein the processor-executable routines, when executed by the processing system, cause the processing system to perform actions. The actions include receiving one or more inputs specifying a first angle for a first set of disc gangs of the tillage implement, a second angle for a second set of disc gangs of the tillage implement, or both the first angle and the second angle. The actions also include providing one or more control signals to actuators to independently alter respective angles of the first set of disc gangs and the second set of disc gangs relative to each other, wherein each disc gang of both the first set of disc gangs and the second set of disc gangs includes a plurality of discs coupled to a respective frame member coupled to a main frame of the tillage implement, the main frame includes a front portion and a rear portion relative a direction of travel of the tillage implement, the first set of disc gangs is located at the front portion, and the second set of disc gangs is located at the rear portion.

In certain embodiments, a method for independently controlling front and rear gang angles on a tillage implement is provided. The method includes receiving, at a controller including a memory and processing system, one or more inputs specifying a first angle for a first set of disc gangs of the tillage implement, a second angle for a second set of disc gangs of the tillage implement, or both the first angle and the second angle. The method also includes providing, via the controller, one or more control signals to actuators to independently alter respective angles of the first set of disc gangs and the second set of disc gangs relative to each other, wherein each disc gang of both the first set of disc gangs and the second set of disc gangs includes a plurality of discs coupled to a respective frame member coupled to a main frame of the tillage implement, the main frame includes a front portion and a rear portion relative a direction of travel of the tillage implement, the first set of disc gangs is located at the front portion, and the second set of disc gangs is located at the rear portion.

In certain embodiments, a non-transitory computer-readable medium is provided. The non-transitory computer-readable medium includes processor-executable code that when executed by a processing system, causes the processing system to perform actions. The actions include receive one or more inputs specifying a first angle for a first set of disc gangs of a tillage implement, a second angle for a second set of disc gangs of the tillage implement, or both the first angle and the second angle. The actions also include providing one or more control signals to actuators to independently alter respective angles of the first set of disc gangs and the second set of disc gangs relative to each other, wherein each disc gang of both the first set of disc gangs and the second set of disc gangs includes a plurality of discs coupled to a respective frame member coupled to a main frame of the tillage implement, the main frame includes a front portion and a rear portion relative a direction of travel of the tillage implement, the first set of disc gangs is located at the front portion, and the second set of disc gangs is located at the rear portion.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a top view of an embodiment of a tillage implement having independent control for front and rear gang angles;

FIG. 2 is a schematic diagram of an embodiment for a system for independent front and rear gang angle control on the tillage implement in FIG. 1;

FIG. 3 is a schematic diagram of an embodiment illustrating a first set of disc gangs and a second set of disc gangs of the tillage implement in FIG. 1 illustrated as lines angled relative to both a centerline of a frame and a direction of travel;

FIG. 4 is a flow diagram of an embodiment of a method for independently controlling front and rear gang angles on a tillage implement;

FIG. 5 is an example of an embodiment of a graphical user interface for independent front and rear gang angle control; and

FIG. 6 is an example of an embodiment of a graphical user interface for altering a gang angle.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

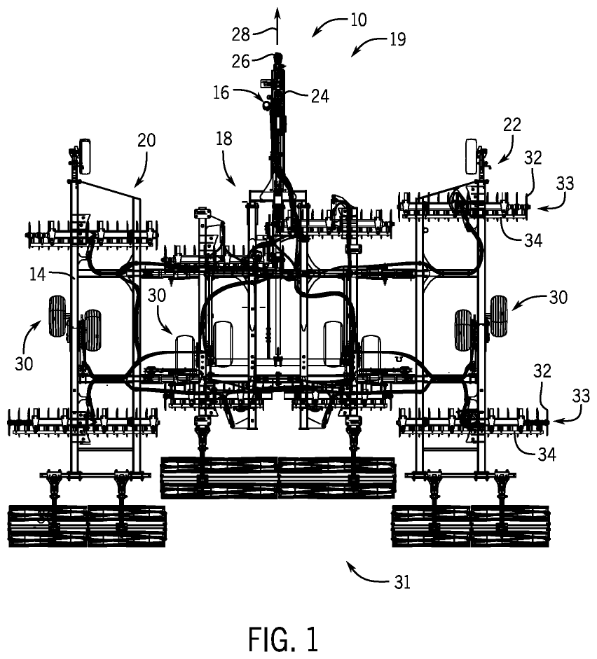

FIG. 1 a top view of an embodiment of a tillage implement 10 having independent control for front and rear gang angles. Independent control and setting of the front and rear gang angles enables better control of output and increases the speed range of the tillage implement 10. Increasing the speed range of the tillage implement 10 increases the productivity of the tillage implement 10. In addition, the utilization of sensor feedback and providing a graphical user interface in the work vehicle enables independent closed loop control for the both the front and rear gangs as well as cab control, data collection, and prescription control.

In the illustrated embodiment, the tillage implement 10 is a vertical tillage implement having multiple ground engaging tools configured to till soil. As illustrated, the tillage implement 10 includes a frame 14 (e.g., main frame) and a hitch assembly 16 coupled to the frame 14. In the illustrated embodiment, the frame 14 includes a center section 18, a left wing section 20, and a right wing section 22. Each wing section is configured to rotate upwardly from the illustrated working position to a transport position to facilitate transport of the tillage implement 10. For example, one or more actuators (e.g., hydraulic cylinder(s), etc.) may be configured to drive each wing section to rotate between the illustrated working position and the transport position. While the frame 14 includes the center section 18, the left wing section 20, and the right wing section 22 in the illustrated embodiment, in other embodiments, the frame 14 may include more or fewer sections. For example, in certain embodiments, the frame 14 may be substantially rigid (e.g., not including any translatable and/or rotatable components). Furthermore, the frame 14 may be formed from multiple frame elements (e.g., rails, tubes, braces, etc.) coupled to one another (e.g., via welded connection(s), via fastener(s), etc.).

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g., tractor), which is configured to tow the tillage implement 10 through a field along a direction of travel 28. The frame 14 includes a front portion 29 and a rear portion 31 relative to the direction of travel 28. While the hitch frame 24 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame and a wheel rotatably coupled to the wheel frame. The wheels of the wheel assemblies 30 are configured to engage the surface of the soil, and the wheel assemblies 30 are configured to support at least a portion of the weight of the tillage implement 10. In the illustrated embodiment, each wheel frame is pivotally coupled to the implement frame 14, thereby facilitating adjustment of the vertical position of the respective wheel(s). However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g., 1, 3, 4, 5, 6, or more). Furthermore, in the illustrated embodiment, each row of disc blades 32 includes four gangs 33 of disc blades 32 (e.g., with four gangs 33 adjacent the front portion 29 and four gangs 33 adjacent the rear portion 31). Two gangs 33 of disc blades 32 of the front row are coupled to the center section 18, two gangs 33 of disc blades 32 of the rear row are coupled to the center section 18, one gang 33 of disc blades 32 of the front row is coupled to the left wing section 20, one gang 33 of disc blades 32 of the rear row is coupled to the left wing section 20, one gang 33 of disc blades 32 of the front row is coupled to the right wing section 22, and one gang 33 of disc blades 32 of the rear row is coupled to the right wing section 22. While the tillage implement 10 includes eight gangs 33 of disc blades 32 in the illustrated embodiment, in other embodiments, the tillage implement 10 may include more or fewer gangs 33 of disc blades 32 (e.g., 2, 4, 6, 10, or more). Furthermore, the gangs 33 of disc blades 32 may be arranged in any suitable configuration on the implement frame.

The disc blades 32 of each gang 33 are non-rotatably coupled to one another by a respective shaft, such that the disc blades 32 of each gang 33 rotate together. Each shaft is rotatably coupled to a respective disc blade support 34 (e.g., frame member), which is configured to support the gang 33, including the shaft and the disc blades 32. Furthermore, each disc blade support 34 is pivotally coupled to the frame 14 at a respective pivot point, thereby enabling the disc blade support 34 to rotate relative to the frame 14. Rotating the disc blade support 34 relative to the frame 14 controls the angle between the respective disc blades 32 and the direction of travel 28, thereby controlling the interaction of the disc blades 32 with the top layer of the soil. Each disc blade support 34 may include any suitable structure(s) configured to support the respective gang (e.g., including a square tube, a round tube, a bar, a truss, other suitable structure(s), or a combination thereof). While the disc blades 32 supported by each disc blade support 34 are arranged in a respective gang 33 (e.g., non-rotatably coupled to one another by a respective shaft) in the illustrated embodiment, in other embodiments, at least a portion of the disc blades 32 supported by at least one disc blade support 34 (e.g., all of the disc blades 32 supported by the disc blade support 34) may be arranged in another suitable configuration (e.g., individually mounted and independently rotatable, mounted in groups and individually rotatable, etc.). For example, in certain embodiments, a first portion of the disc blades 32 supported by a disc blade support 34 may be arranged in a gang 33, and a second portion of the disc blades 32 supported by the disc blade support 34 may be individually mounted and independently rotatable.

While the tillage implement includes the disc blades 32 in the illustrated embodiment, in other embodiments, the tillage implement may include other/additional ground engaging tool(s) (e.g., coupled to the disc blade support(s), coupled to the frame of the tillage implement, etc.). For example, in certain embodiments, the tillage implement may include tillage point assemblies (e.g., positioned behind the disc blades relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), finishing reel(s), other suitable ground engaging tool(s), or a combination thereof. Furthermore, while the tillage implement 10 is a vertical tillage implement in the illustrated embodiment, in other embodiments, the tillage implement may be a primary tillage implement or another suitable type of tillage implement.

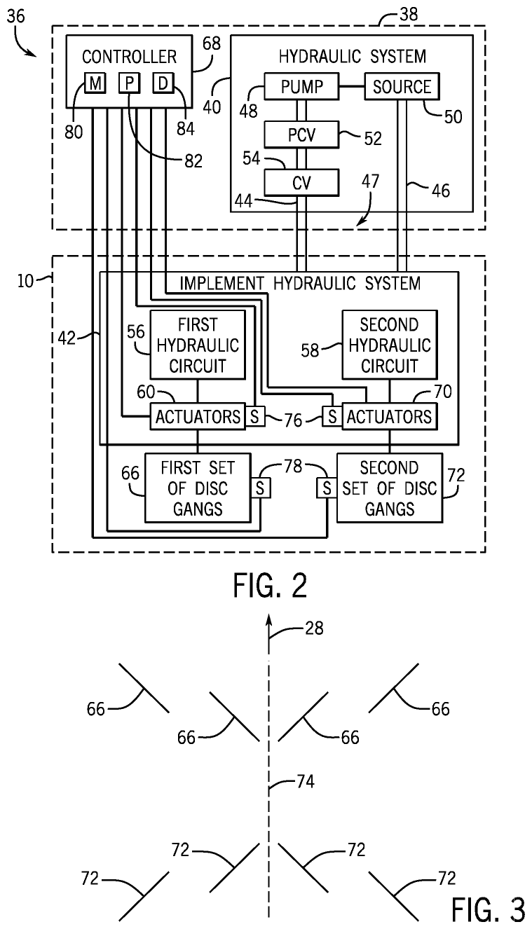

FIG. 2 is a system 36 for independent front and rear gang angle control on the tillage implement 10. As depicted, a work vehicle 38 is coupled to the implement 10 (e.g., tillage implement). The work vehicle 38 includes a hydraulic system 40. The hydraulic system 40 provides pressurized hydraulic fluid to an implement hydraulic system 42 (e.g., hydraulic drive system) via a supply line 44 (e.g., high pressure supply line). Hydraulic fluid is returned to the hydraulic system 40 from the implement hydraulic system 42 at a lower pressure via a return line 46 (e.g., a low pressure return line). The supply line 44 and the return line 46 form a main hydraulic circuit 47. In certain embodiments, there may be multiple supply lines 44 and return lines 46 forming multiple hydraulic circuits between the hydraulic system 40 and the implement hydraulic system 42.

The hydraulic system 40 includes a pump 48 located on the work vehicle 11 that is configured receive hydraulic fluid from a fluid source 50 (e.g., tank) and to provide the fluid (e.g., hydraulic fluid) for output via the supply line 44 to the implement hydraulic system 42. The hydraulic system 40 includes a control valve 52 (e.g., flow control valve) in flow communication with the supply line 44. The control valve 52 is configured to regulate the supply of the hydraulic fluid between the pump 48 and the supply line 44. The hydraulic system 40 also includes a pressure control valve 54 fluidly coupled between the pump 48 and the control valve 52. The pressure control valve 54 is in flow communication with the supply line 44. The pressure control valve 54 regulates the pressure of the hydraulic fluid being supplied to the control valve 52 from the pump 48.

The implement hydraulic system 42 includes a first hydraulic circuit 56 and a second hydraulic circuit 58 coupled to the main hydraulic circuit 47. The first hydraulic circuit 56 is fluidly coupled to a first set of actuators 60 respectively coupled to a first set of disc gangs 66 (e.g., 4 sets of front disc gangs 33 located adjacent the front portion 29 of frame 14 in FIG. 1). The first set of actuators 60 is configured to alter the angle of the first set of disc gangs 66 in response to control signals from a controller 68. The first set of disc gangs 66 are coupled in series with the first hydraulic circuit 56. The angle of the first set of disc gangs 66 is altered at a same time and rate. The second hydraulic circuit 58 is fluidly coupled to a second set of actuators 70 respectively coupled to a second set of disc gangs 72 (e.g., 4 sets of rear disc gangs located adjacent the rear portion 31 of frame 14 in FIG. 1). The second hydraulic circuit 58 is configured to alter the angle of the second set of disc gangs 72 in response to control signals form the controller 68. The second set of disc gangs 72 are coupled in series with the second hydraulic circuit 58. The angle of the second set of disc gangs 72 is altered at a same time and rate. The first hydraulic circuit 56 the second hydraulic circuit 58 are separate and independent from each other, thus, enabling separate and independent front and rear gang angle control.

In certain embodiments, the actuators 60, 70 are hydraulic cylinders. However, in other embodiments, the actuators 60, 70 may include another suitable type of actuating device (e.g., alone or in combination with the hydraulic cylinder), such as a pneumatic cylinder, a hydraulic motor, a pneumatic motor, an electric motor, an electric linear actuator, other suitable type(s) of actuating device(s), or a combination thereof.

FIG. 3 is schematic diagram illustrating the first set of disc gangs 66 and the second set of disc gangs 72 illustrated as lines angled relative to both a centerline 74 of the frame (e.g., frame 14 in FIG. 1) and the direction of travel 28. The angle of the portion of first set of disc gangs 66 to left of the centerline 74 is mirrored relative to the portion of the first set of disc gangs 66 to the right of the centerline 74 (relative to the front portion 29). The angle of the portion of the second set of disc gangs 72 to the left of the centerline 74 is also mirrored relative to the portion of the second set of disc gangs 72 to the right of the centerline 74 (relative to the front portion).

Returning to FIG. 2, in certain embodiments, sensors 76 are coupled to one or more of the first set of actuators 60 and one or more of the second set of actuators 70 to determine respective positions of the actuators 60, 70 to determine the respective positions of the first set of disc gangs 66 and the second set of disc gangs 70. For example, a hydraulic cylinder position (e.g., cylinder length) may be determined. The sensors 76 may be rotosensors, Hall effect sensors, resistance sensors, or other types of sensors. In certain embodiments, sensors 78 are coupled to the main frame adjacent the respective frame members of the disc gangs 66, 72 or are coupled the frame members of the disc gangs 66, 72 to determine the determine respective angles of the respective frame members of the disc gangs (e.g., relative to centerline of the main frame).

The sensors 76, 78 are communicatively coupled to the controller 68 and provide feedback to the controller 68. The controller 68 may be located within a cabin of the work vehicle 38. The controller 68 includes a memory 80 and a processor 82. In some embodiments, the processor 82 may include one or more general purpose processors, one or more application specific integrated circuits, one or more field programmable gate arrays, or the like. Additionally, the memory 80 may be any tangible, non-transitory, computer readable medium that is capable of storing instructions executable by the processor 82 and/or data that may be processed by the processor 82. In other words, the memory 80 may include volatile memory, such as random access memory, or non-volatile memory, such as hard disk drives, read only memory, optical disks, flash memory, and the like.

The controller 68 also includes a display 84 (e.g., touchscreen). The display 84 may serve as both an input device and an output device. The display 84 may display a graphical user interface to enable an operator to input desired angles for both the first set of disc gangs 66 and the second set of disc gangs 72. The operator may also input, via the graphical user interface, a desired range to keep each desired angle within for both the first set of disc gangs 66 and the second set of disc gangs 72. The graphical user interface may display a desired (inputted) angle, an actual angle (as determined by the sensors 76, 78), a desired (inputted) range for both the first set of disc gangs 66 and the second set of disc gangs 72.

The controller 68 is configured to receive one or more inputs specifying a first angle for the first set of disc gangs 66 of the tillage implement 10, a second angle for the second set of disc gangs 72 of the tillage implement 10, or both the first angle and the second angle. In certain embodiments, the first angle and second angle are different. In certain embodiments, the first angle and the second angle are the same. In certain embodiments, the controller 68 receives or obtains a predetermined plan or setting for changing the respective angles of the first set of disc gangs 72 and the second set of disc gangs 72 along the path of the implement through a field. The controller 68 is also configured to provide one or more control signals to the actuators 60, 70 to independently alter respective angles of the first set of disc gangs 66 (e.g., front disc gangs) and the second set of disc gangs 72 (e.g., second disc gangs) relative to each other. In certain embodiments, the controller 68 is configured to receive desired ranges (e.g., ±0.5 degrees) for keeping the first set of disc gangs 66 and the second set of disc gangs 72 within their set angles. In certain embodiments, the controller 68 is configured to provide control signals to actuators 60, 70 (based on feedback from the sensors 76, 78) to maintain the respective angles of the first set of disc gangs 66 and the second set of disc gangs 72 within the respective set angle ranges relative to the respective set angles.

In certain embodiments, the controller 68 is configured to cause display (e.g., on display 84) of a desired (e.g., inputted) first angle of the first set of disc gangs 66 and a desired (e.g., inputted) second angle of the second set of disc gangs 72. In certain embodiments, the controller 68 is configured, based on the feedback from the sensors 76, 78, to cause display (e.g., on display 84) of both a current first angle of the first set of disc gangs 66 and a current second angle of the second set of disc gangs 72.

In certain embodiments, the controller 68 is configured to provide a notification on the graphical user interface when either the current first angle is outside a first desired range from the first angle for the first set of disc gangs 66 or the current second angle is outside a second desired range from the second angle for the second set of disc gangs 72. In certain embodiments, the notification may be a textual notification on the graphical user interface. In certain embodiments, the notification may be changing a color of the display of the current angle value. In certain embodiments, an audible notification may be provided (e.g. via a speaker in the cabin of the work vehicle).

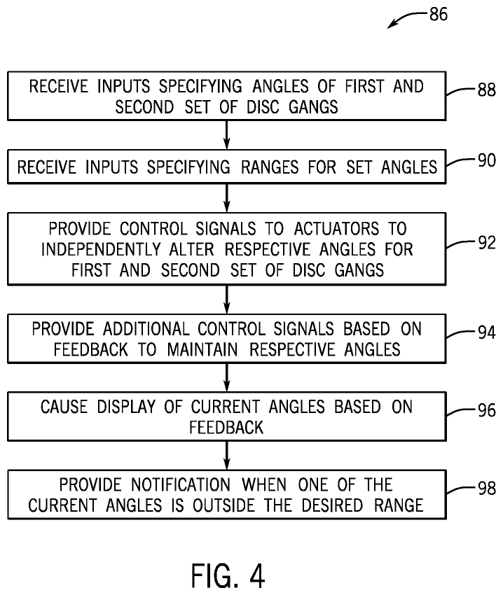

FIG. 4 is a flow diagram of an embodiment of a method 86 for independently controlling front and rear gang angles on a tillage implement (e.g., tillage implement 10 in FIG. 1). One or more steps of the method 86 may be performed by a controller (e.g., controller 68 in FIG. 2). One or more of the steps of the method 86 may be performed simultaneously or in a different order from the order depicted in FIG. 3. One or more (and in some cases) all of the steps of the method 86 may be performed automatically.

The method 86 includes receiving one or more inputs specifying a first angle for a first set of disc gangs (e.g., front disc gangs) of the tillage implement, a second angle for a second set of disc gangs (e.g., rear disc gangs) of the tillage implement, or both the first angle and the second angle (block 88). In certain embodiments, the first angle and second angle are different. In certain embodiments, the first angle and the second angle are the same. In certain embodiments, the method 86 includes receiving one or more inputs specifying desired ranges (e.g., ±0.5 degrees or other desired range) for keeping the respective angles of the first set of disc gangs and the second set of disc gangs near their set angles (block 90). The method 86 also includes providing one or more control signals to actuators to independently alter respective angles of the first set of disc gangs and the second set of disc gangs relative to each other (block 92). The method 86 further includes providing one or more additional control signals, based on feedback from sensors associated with the first set of disc gangs and the second set of disc gangs, to the actuators to maintain both the first angle of the first set of disc gangs and the second angle of the second set of disc gangs within the set (e.g., inputted ranges) (block 94). The method 86 even further includes causing, based on the feedback from the sensors, display of both a current first angle of the first set of disc gangs and a current second angle of the second set of disc gangs on a graphical user interface in a cabin of a work vehicle towing the tillage implement (block 96). In certain embodiments, the method 86 includes providing a notification on the graphical user interface when either the current first angle is outside a first desired (e.g., inputted) range from the first angle or the current second angle is outside a second desired (e.g., inputted) range from the second angle (block 98).

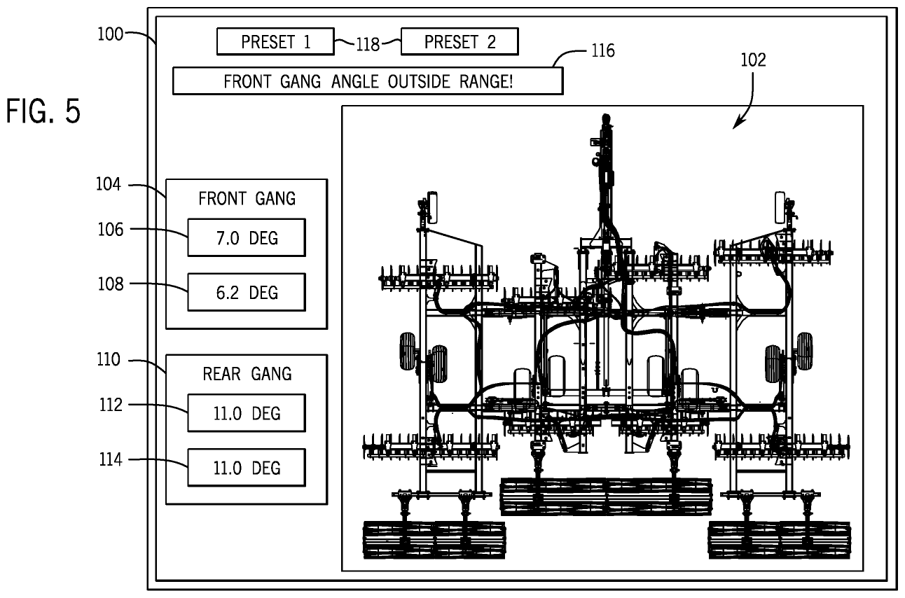

FIG. 5 is an example of an embodiment of a graphical user interface 100 for independent front and rear gang angle control. As depicted, the graphical user interface 100 has a representative image 102 of the tillage implement showing the disc gangs on the front and rear portion of the tillage implement. The graphical user interface 100 includes a button 104 that can be pressed by the user to enable the front gang angle to be set. Displayed on the button 104 are the set (e.g., inputted or desired)) front gang angle 106 and the current front gang angle 108 (based on sensor feedback). The graphical user interface 100 also includes a button 110 that can be pressed by the user to enable the rear gang angle to be set. Displayed on the button 110 are the set (e.g., inputted or desired) rear gang angle 112 and the current rear gang angle 114. In certain embodiments, the current front gang angle 108 or the current rear gang angle 114 will change color, will flash, enlarge (relative to the set angle), or alter in some manner when the current gang angle falls outside of set (e.g., desired or inputted) range relative to the set angle. In certain embodiments, a textual notification 116 may be shown on the graphical user interface 100 when the current gang angle falls outside of set (e.g., desired or inputted) range relative to the set angle. The graphical user interface 100 also includes one or more preset buttons 118 that enable the blades to bet set and/or changed in accordance a predetermined setting.

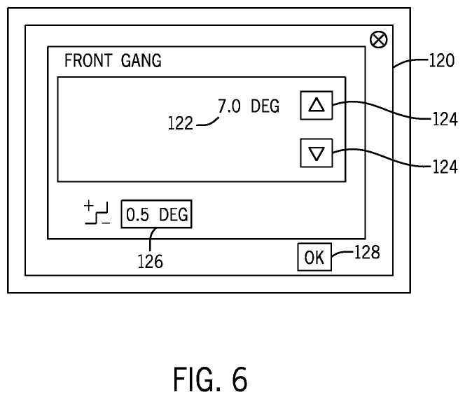

FIG. 6 is an example of an embodiment of a graphical user interface 120 for altering a gang angle (e.g., the front gang angel). The graphical user interface 120 appears on the display when button 104 is pressed on the graphical user interface 100 in FIG. 5. A similar graphical user interface for the rear gang angle would appear if button 110 is pressed on the graphical user interface 100 in FIG. 5. The graphical user interface 120 includes the set front gang angle 122. The graphical user interface 120 also includes buttons 124 (e.g., up/down buttons) to alter the value of the set front gang angle. The graphical user interface 120 further includes a button 126 that can be selected to alter a desired range (e.g., ±0.5 or other value) to keep the current front gang angle (as determined by the sensors) in relative to the set front gang angle. The graphical user interface 120 also includes a button 128 to accept the front gang angle settings.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system for independently controlling front and rear gang angles on a tillage implement, comprising:
a controller comprising:
a memory encoding processor-executable routines; and
a processing system configured to access the memory and to execute the processor-executable routines, wherein the processor-executable routines, when executed by the processing system, cause the processing system to:
receive one or more inputs specifying a first angle for a first set of disc gangs of the tillage implement, a second angle for a second set of disc gangs of the tillage implement, or both the first angle and the second angle; and
providing one or more control signals to actuators to independently alter respective angles of the first set of disc gangs and the second set of disc gangs relative to each other, wherein each disc gang of both the first set of disc gangs and the second set of disc gangs comprises a plurality of discs coupled to a respective frame member coupled to a main frame of the tillage implement, the main frame comprises a front portion and a rear portion relative a direction of travel of the tillage implement, the first set of disc gangs is located at the front portion, and the second set of disc gangs is located at the rear portion.

2. The system of claim 1, wherein the actuators comprise a first set of actuators for altering the first angle of the first set of disc gangs and a second set of actuators for altering the second angle of the second set of disc gangs, the first set of actuators fluidly coupled to a first hydraulic circuit, the second set of actuators is fluidly coupled to a second hydraulic circuit, and the first hydraulic circuit and the second hydraulic circuit are separate and independent from each other.

3. The system of claim 1, wherein the processor-executable routines, when executed by the processing system, further cause the processing system to receive feedback from one or more first sensors associated with the first set of disc gangs and one or more second sensors associated with the second set of disc gangs.

4. The system of claim 3, wherein the processor-executable routines, when executed by the processing system, further cause the processing system to provide one or more additional control signals, based on the feedback, to the actuators to maintain both the first angle of the first set of disc gangs and the second angle of the second set of disc gangs.

5. The system of claim 3, wherein the processor-executable routines, when executed by the processing system, further cause the processing system to cause, based on the feedback, display of both a current first angle of the first set of disc gangs and a current second angle of the second set of disc gangs on a graphical user interface in a cabin of a work vehicle towing the tillage implement.

6. The system of claim 5, wherein the processer-executable routines, when executed by the processing system, further cause the processing system to provide a notification on the graphical user interface when either the current first angle is outside a first desired range from the first angle or the current second angle is outside a second desired range from the second angle.

7. The system of claim 5, wherein the one or more inputs are received via the graphical user interface.

8. The system of claim 3, further comprising the one or more first sensors associated with the first set of disc gangs and the one or more second sensors associated with the second set of disc gangs.

9. The system of claim 8, wherein the one or more first sensors and the one or more second sensors are configured to determine respective positions of the actuators.

10. The system of claim 8, wherein the one or more first sensors and the one or more second sensors are configured to determine respective angles of the respective frame members of the disc gangs.

11. A method for independently controlling front and rear gang angles on a tillage implement, comprising:
receiving, at a controller comprising a memory and processing system, one or more inputs specifying a first angle for a first set of disc gangs of the tillage implement, a second angle for a second set of disc gangs of the tillage implement, or both the first angle and the second angle; and
providing, via the controller, one or more control signals to actuators to independently alter respective angles of the first set of disc gangs and the second set of disc gangs relative to each other, wherein each disc gang of both the first set of disc gangs and the second set of disc gangs comprises a plurality of discs coupled to a respective frame member coupled to a main frame of the tillage implement, the main frame comprises a front portion and a rear portion relative a direction of travel of the tillage implement, the first set of disc gangs is located at the front portion, and the second set of disc gangs is located at the rear portion.

12. The method of claim 11, wherein the actuators comprise a first set of actuators for altering the first angle of the first set of disc gangs and a second set of actuators for altering the second angle of the second set of disc gangs, the first set of actuators fluidly coupled to a first hydraulic circuit, the second set of actuators is fluidly coupled to a second hydraulic circuit, and the first hydraulic circuit and the second hydraulic circuit are separate and independent from each other.

13. The method of claim 11, further comprising receiving, at the controller, feedback from one or more first sensors associated with the first set of disc gangs and one or more second sensors associated with the second set of disc gangs.

14. The method of claim 13, further comprising providing, via the controller, one or more additional control signals, based on the feedback, to the actuators to maintain both the first angle of the first set of disc gangs and the second angle of the second set of disc gangs.

15. The method of claim 13, further comprising causing, via the controller based on the feedback, display of both a current first angle of the first set of disc gangs and a current second angle of the second set of disc gangs on a graphical user interface in a cabin of a work vehicle towing the tillage implement.

16. The method of claim 15, further comprising providing, via the controller, a notification on the graphical user interface when either the current first angle is outside a first desired range from the first angle or the current second angle is outside a second desired range from the second angle.

17. The method of claim 15, wherein the one or more inputs are received via the graphical user interface.

18. The method of claim 13, wherein the one or more first sensors and the one or more second sensors are configured to determine respective positions of the actuators.

19. The method of claim 13, wherein the one or more first sensors and the one or more second sensors are configured to determine respective angles of the respective frame members of the disc gangs.

20. A non-transitory computer-readable medium, the non-transitory computer-readable medium comprising processor-executable code that when executed by a processing system, causes the processing system to:
receive one or more inputs specifying a first angle for a first set of disc gangs of a tillage implement, a second angle for a second set of disc gangs of the tillage implement, or both the first angle and the second angle; and
provide one or more control signals to actuators to independently alter respective angles of the first set of disc gangs and the second set of disc gangs relative to each other, wherein each disc gang of both the first set of disc gangs and the second set of disc gangs comprises a plurality of discs coupled to a respective frame member coupled to a main frame of the tillage implement, the main frame comprises a front portion and a rear portion relative a direction of travel of the tillage implement, the first set of disc gangs is located at the front portion, and the second set of disc gangs is located at the rear portion.
